(19) United States
(12) Patent Application Publication
(10) Pub. No.: US 2011/0300314 A1
(43) Pub. Date: Dec. 8, 2011

(54) Materials between transparent layers for decoration

(76) Inventor: Poyan Taherloo, Copenhagen (DK)

(21) Appl. No.: 13/067,398

(22) Filed: May 31, 2011

(30) Foreign Application Priority Data
Jun. 4, 2010 (DK) PA 2010 00481

(51) Int. Cl. B44C 5/04; B44F 11/04

(52) U.S. Cl. 428/13; 29/525.11

(57) ABSTRACT

Multipurpose decoration consisting in filling and retention of different materials between two or more transparent layers consisting of glass or plastic.

The most important fill material is crushed glass or frit in various colours, grades and shapes.

Decoration is characterized by filling materials in its appearance being separated by means of one or more sheets of different materials with holes for specific fill materials according to the specific pattern, which is located between the two outer transparent layers.

### FIELD OF INVENTION

This invention relates to a multipurpose decorative board, consisting of filling and retention of materials between two or more transparent layers, which may consist of sheets of glass or plastic.

### THE PRIOR ART

The relevant prior art is described in the following documents:

(D1) U.S. Pat. No. 4,944,969 A (USUI) Jul. 31, 1990; (D2) U.S. Pat. No. 6,416,204 B1 (CUTSHAW) Jul. 9, 2002, (D3) U.S. 2005/0276957 A1 (RUNKEL) Dec. 15, 2005.

D1 describes a decoration where various transparent fill materials are placed between a number of transparent sheets, which can consist of glass or plastic.

A frame keeps the sheets so that they form a single unit.

A similar technique is known from D2 and D3, and D1-D3 describes a vast range of materials suitable as filling for a decoration. Materials or objects used as fillings for a decoration, all have the aim to provide a decorative pattern.

The following invention differs from the prior art, as holes in one or more sheets placed between the transparent layers contain fillings. The transparent layers can consist of sheets of glass or plastic, of various properties.

Sheet with holes, forming pockets or rooms for specific fill material is placed on top of one transparent layer, and thus the emergence of pockets or rooms for any fillings, which can then be filled in before the second transparent layer is fitted, thus encapsulating the fill materials and making the decoration a single unit.

This technique and associated method for making decoration, makes it much more accessible to produce decorations, which are also much more accurate according to a particular pattern.

Decoration can also be left without filling materials, and thus only consist of sheet or sheets with holes according to a particular pattern and the surrounding outer transparent layers.

### SUMMARY

Decoration consisting in filling and retention, and thus preservation, of different materials between two or more transparent layers of the same or different sizes, thicknesses and qualities, for use for decoration.

The transparent layers may consist of glass or plastic.

Filling materials are more or less transparent and allow for different amounts and colours of light to penetrate through. The composition of various filling materials shape a specified pattern or motif in form and colour, including on the basis of the materials' different amounts and types of light reflection and penetration.

The most central fill material is crushed glass or frit in various colours, grades and shapes.

Decoration is characterized by filling materials in its appearance being separated by means of one or several sheets of different materials with holes for specific fill materials according to the specific pattern, which is located between the two outer transparent layers.

This technique and associated method for making decoration, makes it much more accessible to produce decorations, which are also much more accurate according to a particular pattern. The single piece of decoration can stand alone or be mounted and included according to specific application.

### DRAWING FIGURES

FIG. 1 should show respectively perspective—and sectional view of decoration consisting of a sheet (4) with holes for any filling materials (2) according to a specified pattern (3), located between two transparent layers (1). To hold together the transparent layers and the intermediate sheet it is possible to use bolts going through (5), where the parts may alternatively be glued together or held together by other methods as for example by using brackets or a frame on the decoration.

FIG. 2 should show cuts for crossings and hole and cut for ends of metal strip/ribbon for the manufacturing method in which this is used to separate filling materials.

### DETAILED DESCRIPTION

### Basic Design

Filling and retention, and thus preservation, of different materials between two or more transparent layers of the same or different sizes, thicknesses and properties of use for decoration.

The transparent layers can consist of for example glass or plastics of different properties.

Filling materials are more or less transparent and allow for different amounts and colours of light to penetrate. The composition of different fillings can shape a specific pattern or motif in form and colour, including on the basis of the materials' different quantities and types of light reflection and penetration.

The most central fill material is crushed glass or frit in various colours, grades and shapes.

Size of pattern and the surrounding transparent layers, and thus the ratio between these may vary according to specific desire or specific application.

First and second transparent layer may have any form of whole piece, as they can have any shape in outline or edges of the layers.

The spacing between the transparent layers may vary depending on decorations' specific application, as the application context in which the decoration is included, or according to specific desire.

With sufficient distance, multiple layers and/or composed as v-shapes, the decoration can stand upright by itself, as a sculpture. With minimum distance the space for fillings is minimal as the transparent layers are glued together.

### Manufacturing

The detailed specific production depends on size and application of decoration. However differences between the production methods, including serial production, actually represent different techniques to separate the different single filling materials in the pattern of decoration. So it is different techniques to produce the dividing walls between different filling materials and thus keep them more accurately separated, according to the pattern. In other words, it is methods to produce pockets for specific fill materials, that can then be filled in before the next transparent layer is mounted, thus encapsulating or preserving filling materials between the two transparent layers.

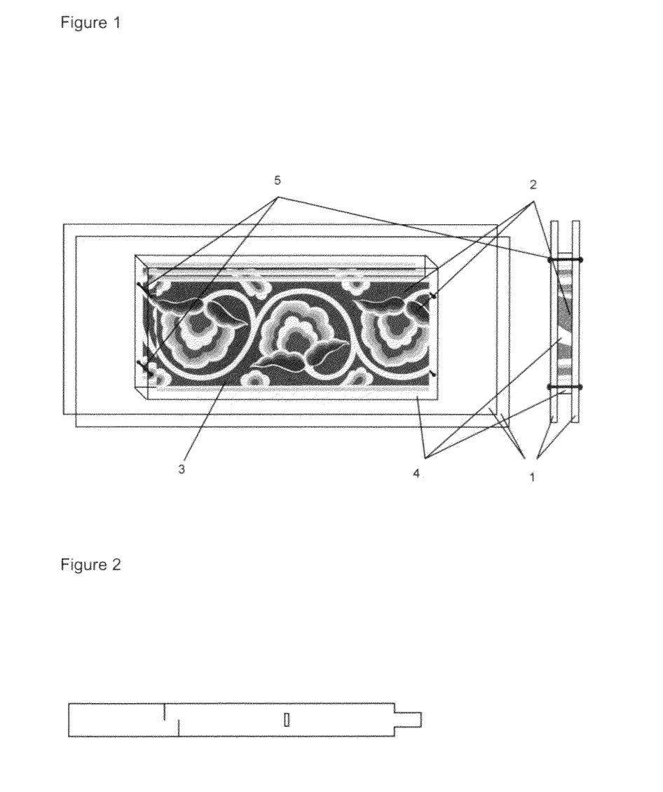

To fasten the parts to each other, the first and second transparent layers and intermediate sheet or frame, it is possible to use different methodologies. Including by means of bolts going through the parts, as shown in FIG. 1 in technical drawing, where the number of bolts, starting at four bolts, may vary depending on specific needs and wishes.

Alternatively to the use of bolts, parts can be glued together or held together in some other manner, as by means of brackets or framework for decoration.

There are especially 2 methods for manufacturing the dividing walls or pockets between the first and second transparent layers, which consists of respectively metal strip/ribbon, or sheet of metal, plastic or other material.

Alternatively, pockets for fill material could be moulded into the intermediate sheet and transparent layers.

Manufacturing procedure for the method with the sheet of metal or plastic could be the same, as dividing walls or pockets for filling materials can be cut from the sheet by laser cutting or water jet cutting.

Alternatively sheets of other materials could be used, such as glass, wood, stone, cement or ceramics, where pockets for fill materials are obtained by using other methods, as for example by moulding.

### Metal Strip/Ribbon

a. Dividing walls, between different colours/types of filling materials are made of metal strip in same width as the distance between the first and second transparent layers, and thus the same thickness as the frame, which may consist of wood, glass, metal, stone or other material.

b. Each metal strip is shaped by pressing it into cuts of the form. Each piece, strip/band is generated so by making a puzzle of the pattern of wood or hard plastic of a thickness that is greater than the width of metal strip/ribbon, then the strip is shaped by pressing two puzzle pieces together on it.

In serial production this can be done by mechanical pistons.

c. When crossing or overlapping cut each strip half way up, and thereby place on top of each other, to achieve the same common width as the strip, as shown in FIG. 2 of technical drawing.

d. The ends of the strip relative to frame or a second strip in the pattern, cut to size as shown in FIG. 2 in technical drawing. The tip is inserted into the hole and then bended, or bended and glued to frame according to the angle of the pattern. Holes and ends in metal strip/band are performed mechanically.

e. Aluminium is an ideal metal for this purpose, especially for mass production because of formability, strength and weight. Metal strip may also consist of other metals such as various precious metals, also to achieve different reflections on additional fill material in pattern.

### Sheet Metal or Plastic or Other Material

Aluminium is the most suitable metal for this method because of the low weight, but other metals can also be used.

Acrylic or Plexiglas in clear transparent form, or in other colours, different thicknesses and properties, is the most suitable for this method, but other plastics may also be used.

In contrast to the method for metal strip/ribbon, framework and dividing walls are of one and the same piece in the form of a sheet metal or plastic, possibly with holes for bolts. The specific pockets for filling materials according to the pattern, which thus is enclosed by the sheet in appearance, are cut from the sheet of metal or plastic through means of for example laser cutting or water jet cutting.

Manufacturing procedure for the manufacture with for example sheet of metal or plastic, where holes are cut by using for example laser cutting, are as following:

a. sheet of metal or plastic with holes which form pockets for specific fill materials, cut out of the sheet by means of laser cutting, is placed on top of the first transparent layer;

b. any filling materials selected according to specific pattern is filled in the pockets;

c. the second transparent layer is then mounted on top, thus encapsulating the filling materials, after which the parts are fastened to each other, and the decoration is now a single piece.

d. This process is repeated if there are more than two transparent layers in the decoration.

The final total piece can then stand alone or be mounted and included according to more specific application of the decoration.

### Filling Materials

Materials to fill the pattern depend on the size of the total peace and the specific use, and include:
Small pieces of glass, including frit, of various colours, shapes, types, and grades;
Shavings of various types of metals or plastics of different colours, grades and shapes;
Different types of stones, wood, sand, ceramics and gravel in various grades, types, colours, formations and shapes;
Various natural materials such as live or dried leaves, fruits, flowers, beans, berries, plants, water and ice; Air;
Different types of beads; and
Cuts from sheets.

Depending on the decoration, such as for outdoor use as railings, exterior decoration, doors and windows, or where fill materials are natural materials or materials that need to be preserved, an exceptional seal is needed for fillings and pockets in relation to its surroundings, so that no air or moisture penetrates into these and causes damage.

### Installations

Arrangements that in different ways are part of the pattern or picture:
Water, steam and ice—where electrical power is required when installing respectively pump, heating element and cooling element. This type of installation requires the use of separate tubes in the decoration.
Light of different colours and strengths from the back of the frame lights up on the pattern/picture from different angles and are mounted so that they are not visible from the fronts of the picture.

Furthermore, the transparent layers or specific areas of these can have different properties in surface strength, warpage, engravings, etc.

### Applications

The decoration is a multipurpose panel, board, piece, unit or form for all applications in x, y and z axis.

The applications of this decoration design are numerous, and include:
Art and decoration in various sizes: pictures for wall, floor or front of a window different kinds of sculptures, including positioned relative to light in a room;
Part of signage and advertising with the company name, logo, etc.;
Workable decoration as tabletops, room dividers for room and office, floor decoration after gold carpeting, lighting appliances, shelves for shelving and other display cases and showcases and frames to pictures, mirrors and more; trays, coasters or dew, umbrellas, blinds, heaters and refrigeration equipment;
Decorations for the manufacture of doors and windows of various sizes and types;
Building decoration, decorative facades, balconies, as railings, walls and roofs, floor structures, visors, etc. or frames installed as a mosaic on gables or walls, both indoors and outdoors.

What is claimed is:

1. Decoration consisting in filling and retention, and thus the preservation of various filling materials between two or more transparent layers (1), of the same or different sizes, shapes, thicknesses and properties.
Filling materials (2) are more or less transparent and allow for various quantities and colours of light to penetrate. The composition of different fillings can form a specific pattern or motif in shape and colour (3), including on the basis of the materials' different amounts and types of light reflection and penetration.
Sizes on pattern and the surrounding transparent layers, and thus the ratio between these may vary according to specific desire or application. First and second transparent layers (1) may have any form in whole of the piece, as they can have any shape in outline or edges of the layers. The spacing between the outer transparent layers can vary depending on the specific application of decoration, as in the application context the decoration is included, or according to specific desire. The single piece of decoration can then stand separately or be included according to specific application.
Decoration is characterized by that the filling materials used in the decorations appearance are segregated, using a sheet of different materials and properties (4), including for example metal, plastic, wood, glass or stone, with holes for specific fill materials according to the specific pattern, which is located between the two outer transparent layers.
The sheet size, extension and location relative to the surrounding outer transparent layers may vary according to specific application or specific request.
There may also be several separate sheets, including those of different materials in the overall pattern, which is surrounded by the outer transparent layers.
Decoration is also able to stand without filling materials, and thus only consist of sheet or sheets with holes according to specific pattern and the surrounding transparent layers.
There may also be only a single hole in a sheet, one space or one room for filling materials, so that the sheet constitute a frame on a specific shape with surrounding transparent layer.

2. Decoration according to claim 1 characterized by that the transparent layers may consist of glass of different sizes, shapes, thicknesses and properties.

3. Decoration according to claim 1 characterized by that the transparent layers can consist of plastic of various sizes, shapes, thicknesses and properties.

4. Decoration according to claim 1 characterized by the fill materials including:
Small pieces of glass, including frit, of various colours, shapes, types and grades;
Shavings of various types of metals and plastics of different colours, grades and shapes;
Different types of stones, wood, sand, ceramics and gravel in various grades, types, colours, formations and shapes;
Various natural materials such as live or dried leaves, fruits, flowers, beans, berries, plants, water and ice;
Air;
Different types of beads;
Cuts from sheets.
Decoration according to claim 1 characterized by the possibility of using installations in the decoration, including electric lights, electric heater, electric cooling element as well as special properties in the transparent layers or parts thereof, such as surface strength, warpage, engravings, etc.

5. Method for producing a decoration according to claim 1 characterized by that the filling materials can be separated by means of sheet with holes.
Sheet with holes, forming pockets or rooms for specific fill materials is placed on top of one transparent layer, thus creating the emergence of pockets or rooms for any fillings, which can then be filled in before the second transparent layer is fitted, thus encapsulating the filling materials and making decoration stand as a single unit.
This could be a sheet of plastic or metal, in which holes are cut by means of for example laser cutting or water jet cutting, or alternatively the holes can be moulded in the sheet.
This procedure is as follows:
a. sheet with holes according to certain pattern, forming pockets and rooms for any specific fill materials is placed on top of the first transparent layer; so pockets or rooms for any filling are obtained by sheet with holes positioned between the two outer transparent layers;
b. specific filling materials selected according to specific pattern is filled in those pockets, if the decoration include filling materials;
c. the second transparent layer is mounted on top and encapsulates any fill materials, after which the parts are fastened to each other, and the decoration is now a single unit.
d. to fasten the parts to each other, the first and second transparent layers and intermediate sheet or sheets, different methods may be used. Including by means of bolts going through (5), where the number of bolts starting at four may vary depending on specific needs and wishes.
Alternatively to the use of bolts, the parts can be glued together or held together in some other manner as by means of brackets or framework for decoration.
e. this process is repeated if there are more than two transparent layers in the decoration.
f. the final total piece can then stand alone or be mounted and included according to more specific use of decoration.

6. Application according to claim 1 is the decoration as multipurpose panel, board, piece, unit or form for all applications in x, y and z axis.
The applications of decoration include:
Art and decoration in various sizes: pictures for wall, floor or front of a window; different kinds of sculptures, including positioned relative to light in a room;
Part of signage and advertising with the company name, logo, etc.;
Workable decoration as tabletops, room dividers for room and office, floor decoration after gold carpeting, lighting appliances, shelves for shelving and other display cases and showcases and frames to pictures, mirrors and more; trays, coasters or dew, umbrellas, blinds, heaters, cooling apparatus;
Decorations for the manufacture of doors and windows of various sizes and types;
Building decoration, decorative facades, balconies, as railings, walls and roofs, floor structures, parasols, etc. or frames installed as a mosaic on gables or walls, both indoors and outdoors.
